(19) United States
(12) Patent Application Publication
(10) Pub. No.: US 2015/0249936 A1
(43) Pub. Date: Sep. 3, 2015

(54) PARALLEL AGGREGATE MAC PROTOCOL DATA UNITS FOR FAST LINK ADAPTATION

(71) Applicant: Magnolia Broadband Inc., Englewood, NJ (US)

(72) Inventors: Phil F. CHEN, Denville, NJ (US); Haim HAREL, New York, NY (US); Kenneth KLUDT, San Jose, CA (US)

(21) Appl. No.: 14/306,458

(22) Filed: Jun. 17, 2014

Related U.S. Application Data
(60) Provisional application No. 61/946,305, filed on Feb. 28, 2014.

(51) Int. Cl. H04W 28/06

(52) U.S. Cl. CPC H04W 28/065; H04W 84/12

(57) ABSTRACT

A method of wireless data transmission may include generating, by a processor, two or more aggregated MAC protocol data units (A-MPDU's) in parallel. Each A-MPDU may be generated by aggregating MAC protocol data units (MPDU's) for different modulation coding schemes. The processor may determine a modulation coding scheme for data transmission. The processor may further transmit one of the A-MPDU's based on the determined modulation coding scheme.

### CROSS REFERENCE TO RELATED APPLICATIONS

This application claims benefit of U.S. Provisional Patent Application No. 61/946,305 filed Feb. 28, 2014.

### FIELD OF THE PRESENT INVENTION

The present invention relates generally to the field of Wi-Fi; the 802.11 a, b, g, n, ac standards; antenna arrays; receivers; transmitters; beamforming; digital signal processing digital filtering; and interference mitigation.

### BACKGROUND

In the OSI (Open Systems Interconnection) layer model, each entity, PHY and MAC, offers services to the entity in the layer immediately above it and user data may be transferred between the layers as a service data unit (SDU). The MAC receives data from the logical link control (LLC) layer, and delivers data to the LLC layer through the MAC SDU (MSDU). The PHY layer receives data from the MAC layer and delivers data to the MAC layer in a PHY SDU (PSDU).

A protocol may be the means by which entities in the layered model exchange data and control information with their peer entities (e.g., between access points or between access points and user equipment being served by the access points). This exchange may take place through protocol data units (PDUs). The MAC exchanges MAC PDUs (MPDUs) with its peer and the PHY exchanges PHY PDUs (PPDUs) with its peer. Link adaptation may be a process by which a wireless transmitter (on an access point, for example) selects an optimal MCS (Modulation Coding Scheme) with which to send data to a particular receiver (on a user equipment, for example). A MCS may map a measured SINR (Signal to Interference plus Noise Ratio) to modulation order and code rate. Link adaptation algorithms may generally be based on a measured packet error rate (PER). WiFi and other CSMA/CS (Collision Sense Multiple Access/Carrier Access) protocols may be implemented with a limited amount of frequency resources that use techniques of collision avoidance to allow multiple user equipments (UE's) to share the same channel. As the numbers of UEs and APs proliferate, the impact of such a scheme restricts the ability of Wi-Fi access points (APs) to support an ever increasing number of users.

### SUMMARY

A method of wireless data transmission may include generating, by a processor, two or more aggregated MAC protocol data units (A-MPDU's) in parallel. Each A-MPDU may be generated by aggregating MAC protocol data units (MPDU's) for different modulation coding schemes. The processor may determine a modulation coding scheme for data transmission. The processor may further transmit one of the A-MPDU's based on the determined modulation coding scheme.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram of neighboring access points according to embodiments of the invention.

FIG. 2 is a diagram of generating an A-MPDU based on Enhanced Distributed Channel Access (EDCA) mode, according to embodiments of the invention.

FIG. 3 is a diagram of A-MPDU's encapsulation, according to embodiments of the invention.

FIG. 4 is a chart illustrating the effect of aggregation on throughput in different 802.11 standards, according to embodiments of the invention.

FIG. 5 is a block diagram illustrating transmitter processes for the OFDM PHY layer that may be integrated within an AP configuration, according to embodiments of the invention.

FIGS. 6A and 6B are MCS tables for 20 MHz basic rates, according to embodiments of the invention.

FIG. 7 is a block diagram of generating two or more A-MPDUs, according to embodiments of the invention.

FIG. 8 is a flow chart of a possible method of aggregating multiple A-MPDUs according to an embodiment of the invention.

FIG. 9 is a flow chart of a method, according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may be described in reference to the IEEE (Institute of Electrical and Electronics Engineer) 802.11 standard for implementing wireless local area networks (WLAN). The IEEE 802.11 standard may also be known as the Wi-Fi standard. “802.11xx” may refer to any version of the 802.11 standard, such as 802.11a, 802.11g, or 802.11ac, for example. Versions of the 802.11 standard may operate using a technique called Collision Sense Multiple Access/Collision Avoidance (CSMA/CA), a networking method which aims to prevent transmission collisions before they occur. While embodiments of the invention are described in terms of the 802.11 protocol, other network protocols built on the CSMA/CA concept may be used.

As used herein, wireless access points (AP's) or transceivers may be used interchangeably as any device having independent transmit and receive functions and capable of acting as a 802.11xx access point. Further as used herein, “beamforming” may refer to the ability to direct data towards a narrow azimuth with high gain or power. Transceivers or access points may affect neighboring or adjacent access points if, under ordinary usage of the CSMA/CA technique, data transmission from one transceiver prevents simultaneous data transmission from another adjacent transceiver on the same channel or frequency. The transceivers' proximity to each other may cause, for example, RF interference, a busy CCA, or an updated NAV, as explained further below.

The term “beamformer” as used herein refers to analog and/or digital circuitry that implements beamforming and may include combiners and phase shifters or delays and in some cases amplifiers and/or attenuators to adjust the weights of signals to or from each antenna in an antenna array. Digital beamformers may be implemented in digital circuitry such as a digital signal processor (DSP), field-programmable gate array (FPGA), microprocessor or the central processing unit “CPU” of a computer to set the weights as may be expressed by phases and/or amplitudes of the above signals. Various techniques are used to implement beamforming including: Butler matrices, Blass Matrices and Rotman Lenses. In general, most approaches may attempt to provide simultaneous coverage within a sector using multiple beams.

Access points (AP's) using a CSMA/CA wireless network, including IEEE 802.11 WiFi networks, may determine whether a radio channel is clear, prior to broadcasting or transmitting data in the channel. The AP may do this by performing a clear channel assessment (CCA), which includes two functions: listening to received energy on an RF interface (termed “energy detection”), or detecting and decoding an incoming Wi-Fi signal preamble from a nearby AP. A signal preamble may be a signal used to synchronize transmission timing between two devices and may occur at the beginning of every data packet. In a communication standard such as Wi-Fi, a preamble may have a predefined structure and data fields organized in a way that all devices communicating on the standard understand. A CCA is deemed ‘busy’ and thus not available if an AP's receiver can sense radio energy, from another AP, above a CCA sensitivity level or if an AP detects an incoming WiFi signal preamble. The AP may also maintain a Network Allocation Vector (NAV), which acts as a countdown timer to when the AP may begin to transmit data. Based on signals from nearby AP's which may indicate the length of a transmitted data packet, an AP's NAV may update the time to transmission, causing further delay to an AP's data transmission. An AP may defer from using the channel to transmit data until both conditions (e.g., CCA deemed ‘busy’ and the NAV timer) have expired.

AP's or transceivers may serve or cover a local geographic area by transmitting data to wireless stations (STA's), which may be user equipment devices (UE's). UE's may be a cell phone, smart phone, tablet or any device with Wi-Fi capability and able to communicate with a Wi-Fi access point, or another wireless capable device. The coverage of adjacent or neighboring APs may have overlapping areas due to the CCA as explained above. There may be a potential for interference when adjacent APs illuminate or serve the same area on the same frequency. One AP may null its transmission signal in the direction of the neighboring AP. Using Tx (transmit) and Rx (receive) nulling by an AP may reduce the interference from one AP to another AP on the same frequency so that both neighboring APs may continue to communicate simultaneously with their STA's or UE's. Nulling or canceling a transmit or receive signal in a particular direction may mean adjusting phase shift or attenuation values of a transmitting or receiving signal. When transmitting data according to a CSMA/CA protocol such as 802.11, AP's may use a MCS to pack or aggregate multiple MPDU's together into a data frame, in order to reduce overhead and average them into multiple frames. The nulling AP may require a change to the MCS used in transmitting data if it determines that its STA or UE may be able to receive data with a lower SNR than in a clear channel situation (e.g., when no interference is detected and no nulling is required). Changing MCS may be necessary to avoid MCS mismatch which may result in greater packet error, and thus defeating the purpose of increasing channel access through nulling. For fast link adaptation, an AP or STA may also change the MCS when the AP or STA receives MCS feedback from its receiver.

Embodiments of the present invention may include a method of generating, in parallel, two or more A-MPDU's (aggregated MPDU's), where each A-MPDU aggregates MAC protocol data units (MPDUs) for different modulation coding schemes (MCS's). The method may further select one of the generated A-MPDU's for transmission in response to recent MCS, CTS and ACK feedback signals. The selection of one A-MPDU out of multiple A-MPDUs may operate with a standard link adaption algorithm in the MAC layer and may provide less delay than generating a single A-MPDU and changing the MCS on the single A-MPDU. Two or more A-MPDU's may be generated in parallel by generating, simultaneously or contemporaneously, two or more A-MPDU's having different modulation coding schemes and storing them in memory until a transmission opportunity exists and an A-MPDU is selected for transmission.

Before explaining the embodiments of the invention in detail, it is to be understood that the invention is not limited in its application to the details of construction and the arrangement of the components set forth in the following descriptions or illustrated in the drawings. The invention is applicable to other embodiments and may be practiced or carried out in various ways. Also, it is to be understood that the phraseology and terminology employed herein is for the purpose of description and should not be regarded as limiting. In the description that follows, the procedure of generating multiple A-MPDUs in parallel and selecting a MCS for transmission is described in detail.

Two APs transmitting at or on the same channel may also interfere with each other. One embodiment of the invention, an AP detects preamble from another AP and adjusts its Tx and Rx null toward that interfering AP and transmits data to an UE in lower MCS since the UE may receive weaker signal resulting in poor SNR from its associated AP than clear channel situation. Embodiments of the invention provide a method whereby the selection of MCS has no delay by providing multiple A-MPDUs in parallel.

Embodiments described herein may relate primarily to AP's performing aggregation of MPDU's. However, embodiments of the invention are not limited to APs and may also be applicable to other stations and UE's which are performing selection of MCS or fast link adaptation.

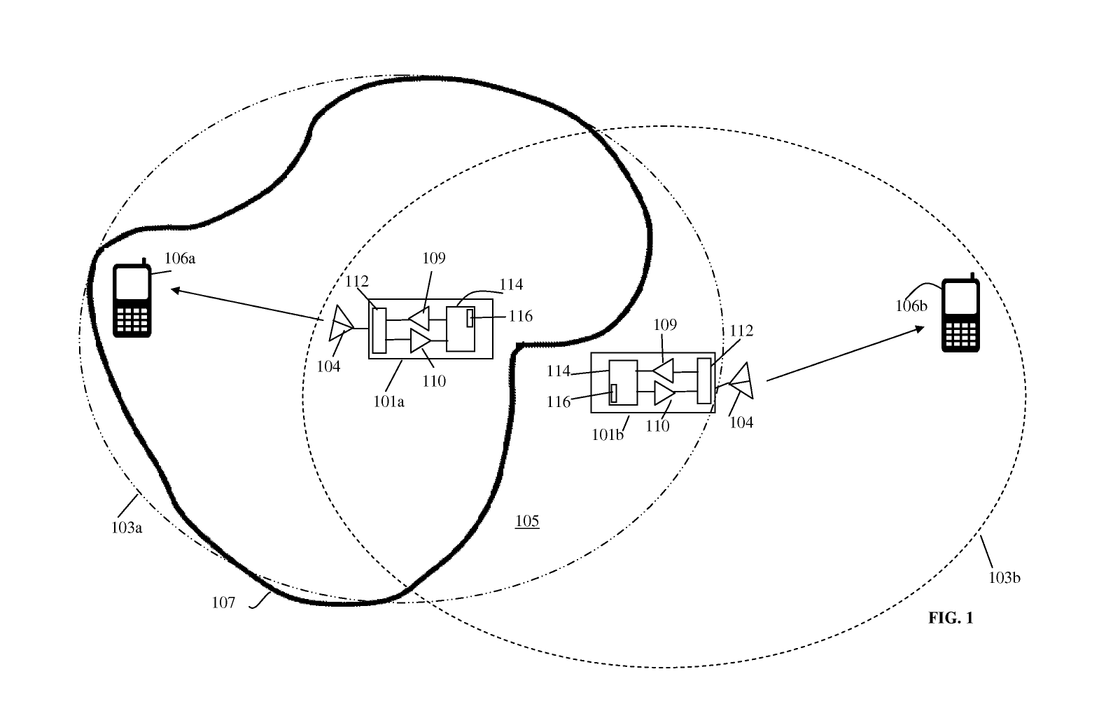

FIG. 1 is a diagram of neighboring access points according to embodiments of the invention. A first access point or transceiver 101a and a second access point or transceiver 101b may serve respective coverage areas 103a and 103b using the same frequency resources, for example. First access point 101a and second access point 101b may be adjacent to each other and have an overlapping coverage area 105. Each access point 101a and 101b may be coupled to an antenna 104 which may form directive beams to transmit data to UE's or STA's 106. A UE 106 may be a cell phone, smart phone, tablet or any device with Wi-Fi capability and able to communicate with a Wi-Fi access point, or another wireless capable device. UE's 106 may be recognized in a WLAN as a Station (STA) device, according to the IEEE 802.11xx protocol. Each access point 101a and 101b may operate according to the IEEE 802.11xx protocol, or other protocol using CSMA/CA. The access points 101a and 101b may each include for example a transmitter 109, receiver 110, antenna interface or RF circuitry 112, and a processor 114 and memory 116, although other or different equipment may be used. Processor 114 may be a general purpose processor configured to perform embodiments of the invention by for example executing code or software stored in memory 116, or may be other processors, e.g. a dedicated processor. Transmitter 109 and receiver 110 may themselves be processors.

As shown in FIG. 1, the first access point 101a may interfere with data transmission from access point 101b, due to the overlapping coverage area 105. When second access point 101b transmits data to UE 106b which resides in the second access point's coverage area 103b, the first access point's 101a CCA may, according to the ordinary implementation of the 802.11 standard, delay data transmission from the first access point 101a until its NAV timer counts down to zero or another CCA is deemed clear. To avoid triggering the NAV timer in the first access point 101a, first access point 101a may be able to provide directive beamforming to UE 106a and null or cancel its transmission and reception in the direction of the second access point 101b. A modified radiation pattern 107 of the first access point's 101a data transmission may avoid triggering the first access point's 101a CCA or NAV timer and may also reduce the SNR of data transmitted to UE 106a. Prior to transmitting data to UE106a, first access point 101a may provide or generate two or more A-MPDU's, each being an aggregation of MPDU's using a different MCS. The two or more A-MPDU's may be stored in memory 116 or temporarily stored in random access memory located in the transmitter 109, for example. Processor 114 may provide or generate the two or more A-MPDU's and select one of the A-MPDU's to transmit to UE 106a. The selection may be based on feedback signals from the UE 106a, for example.

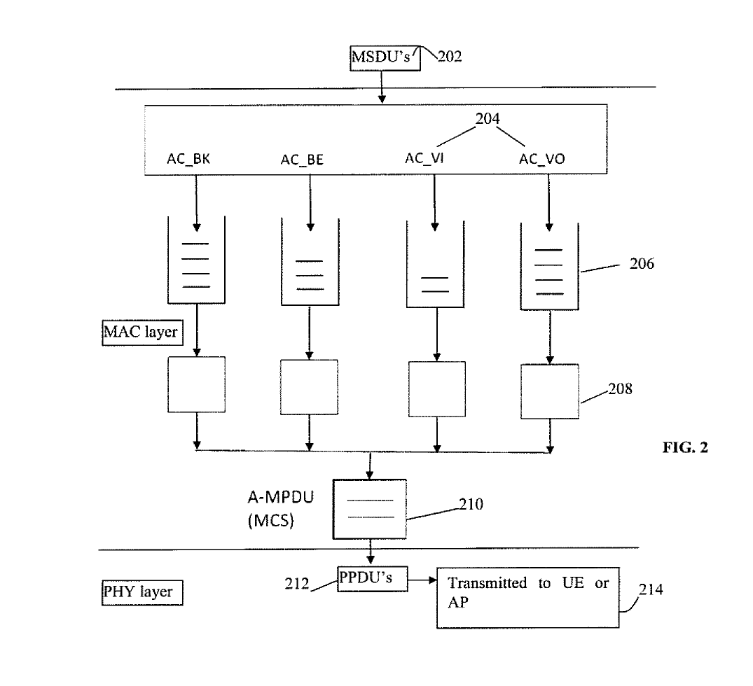

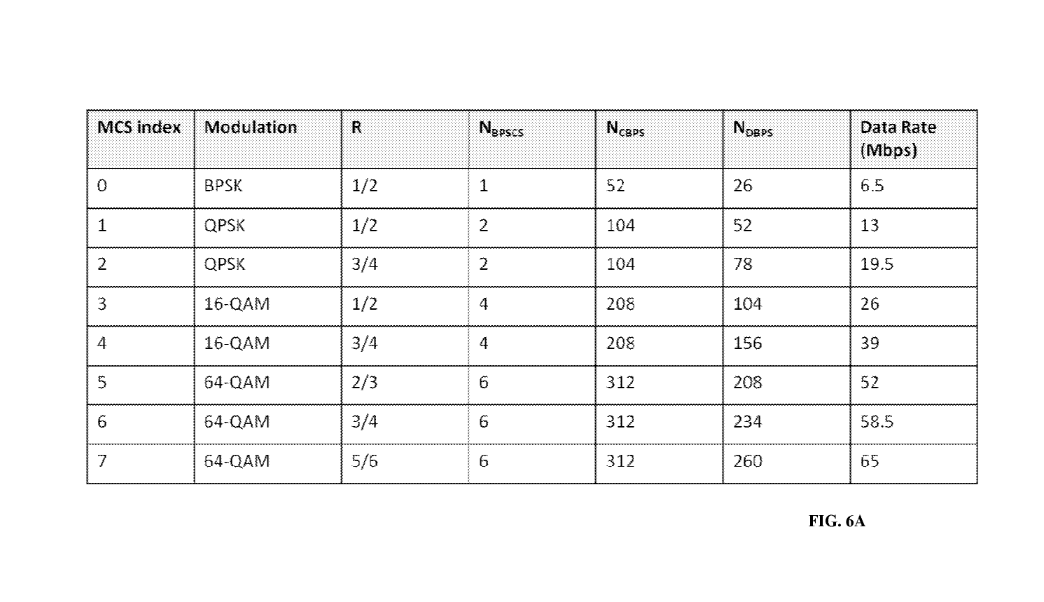

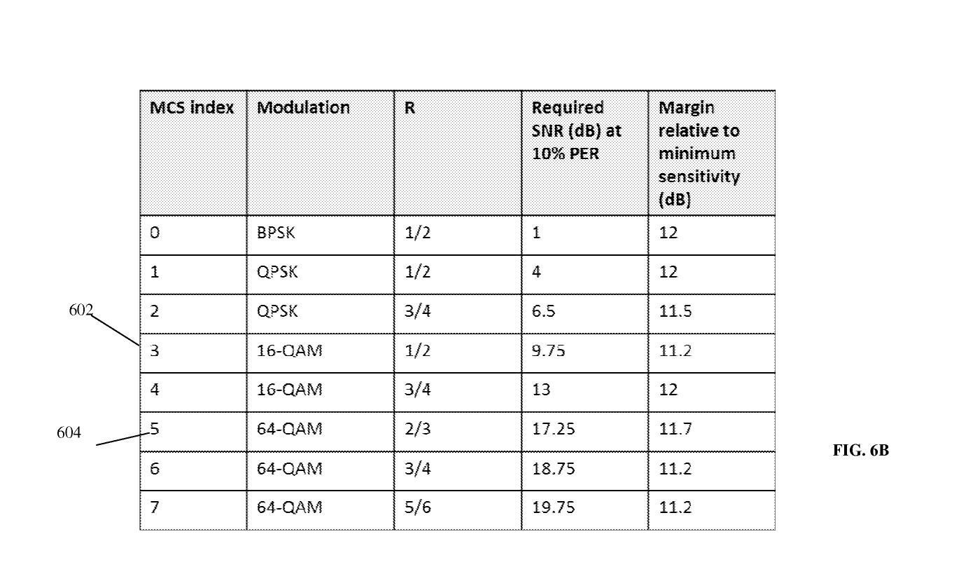

FIG. 2 is a diagram of generating an A-MPDU based on Enhanced Distributed Channel Access (EDCA) mode, according to embodiments of the invention. EDCA may provide 802.11 Quality of Service (QoS) scheduling and may enhance MAC throughput. The EDCA mechanism may define four access categories (ACs) 204. Each AC may be characterized by specific values for a set of access parameters that statistically prioritize channel access for one AC over another. The relative access priorities of the four ACs may be mapped to 802.1D (MAC bridging) user priorities. Each MSDU (MAC service data unit) 202 from the data link layer may have a particular user priority and may belong to a traffic category (TC) with that user priority. Based on these priorities, each MSDU may be mapped to an AC 204. For example, according to the 802.11 protocol, access categories may be defined as Background 204a, Best Effort 204b, Video 204c, or Voice 204d. Video and Voice data categories may require low latency between packets and thus higher priority in the data queue. MSDU's in each AC may be lined up in queues 206. If two (or more) instances of the EDCA access function gain access simultaneously, the internal collision 208 is resolved by the highest priority AC gaining access and the other AC behaving as if an external collision occurred by doubling its contention window and re-arming for another access attempt. The MSDU's may be aggregated or generated into an A-MPDU 210 using a particular or determined MCS (further explained in FIG. 6A for example). The A-MPDU 210 may be pushed to a PPDU 212 and transmitted 214 to another device able to receive 802.11 data, such as a UE or other AP.

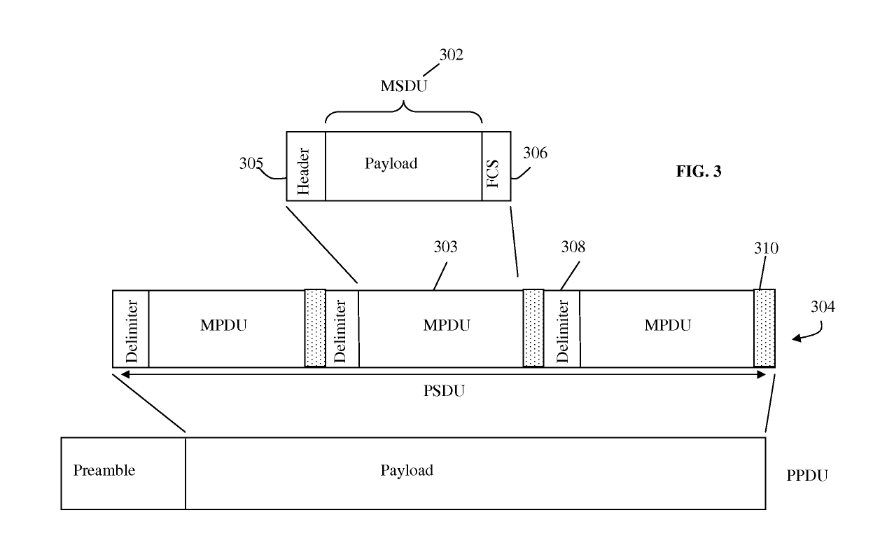

FIG. 3 is a diagram of A-MPDU's encapsulation, according to embodiments of the invention. MSDU's 302 from the data link layer may be queued into aggregated MPDU's 304, according to the EDCA function and the MSDU's access category. Each MPDU 303 may include a MSDU, MDPU header 305 and a frame check sequence (FCS) 306 for error detection. The FCS field 306 may contain a number that is calculated by the source node based on the data in the frame. An A-MPDU 304 may include a series of MPDU's 303 along with a MPDU delimiter 308 and padding 310 between each MPDU 303. A-MPDU 304 aggregates multiple MPDUs to form the PSDU that is passed to the PHY layer to form the payload of a single transmission.

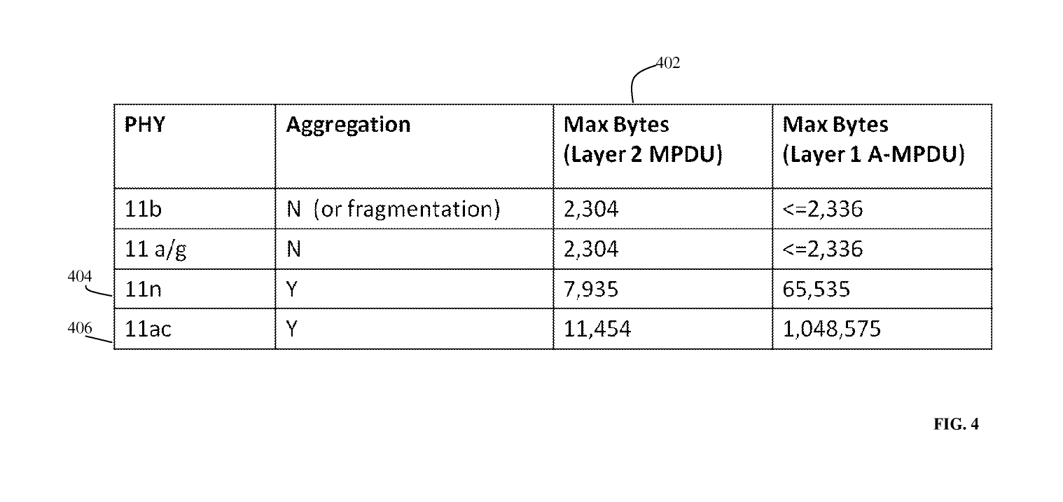

FIG. 4 is a chart illustrating the effect of aggregation on throughput in different 802.11 standards, according to embodiments of the invention. The 802.11n standard may be the high throughput (HT) amendment to the 802.11 standard. 802.11 ac, also known as Very High Throughput (VHT), may be positioned as the successor to 802.11n. Like previous evolutions within WLAN, 802.11 ac may be designed to be fully backward compatible with previous standards. The maximum length MPDU 402 that a station can receive in a HT PPDU (802.11n) 404 and in a VHT PPDU (802.11ac) 406 may be 7935 bytes and 11,454 bytes respectively as shown. A station or UE may advertise the maximum A-MPDU length that it can receive in an HT PPDU in its HT Capabilities element. The advertised maximum length may be one of the following: 8191, 16383, 32767, or 65535 bytes. A station or UE may also advertise the maximum A-MPDU length that it can receive in a VHT PDDU in its VHT Capabilities element. The advertised maximum length may be up to 1,048,575 bytes. The sending station (e.g., an access point) may not send an A-MPDU of greater length.

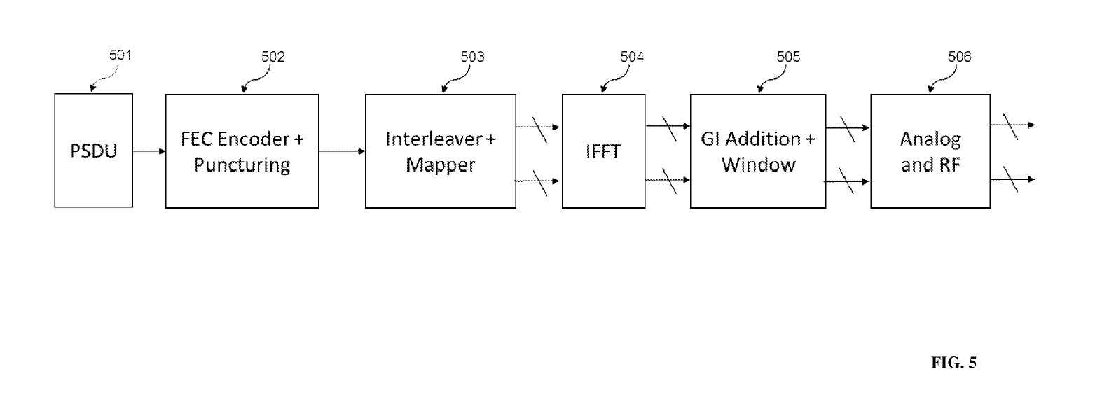

FIG. 5 is a block diagram illustrating transmitter processes for the OFDM PHY layer that may be integrated within an AP configuration, according to embodiments of the invention. In operation 501, the PHY layer may receive data from the MAC in a PHY SDU (PSDU). In operation 502, the data may be encoded with a rate ½ binary convolutional encoder (BCC) in a FEC encoder block. If necessary, the sequence may be punctured to the selected code rate if a higher rate is chosen. FEC encoder block 502 may also use the optional low density parity check (LDPC) encoding process. Following the FEC encoder, the coded data may be block interleaved with two permutations, modulated in one of the following modulations possible: BPSK, QPSK, 16-QAM, 64-QAM and 256-QAM, according to the selected MCS, and mapped onto the corresponding subcarriers at block 503, Interleaver/Mapper. At this stage, the modulated data may be complex numbers. For each symbol, the pilot subcarriers may be inserted into their corresponding subcarriers. Each symbol group of subcarriers may be transformed into the time domain by IFFT (inverse fast Fourier transform) block 504 and the time domain symbol may be prepended cyclic prefix as Guard Interval by GI Addition/Window block 505. A pulse shaping function or windowing function may be applied to each symbol to smooth transitions between symbols. Lastly, each of the OFDM symbols may be appended one after another. The digital baseband signal may be converted to analog with a digital-to-analog converter, which is then followed by an up-converter to RF and a power amplifier by Analog/RF block 506.

FIGS. 6A and 6B are MCS tables for 20 MHz basic rates, according to embodiments of the invention. The basic rates may include equal modulation and the mandatory 800 ns guard interval. In 802.11n, the MCS may refer to modulation, coding and spatial streams for 20 MHz and 40 MHz channel bandwidth. In 802.11 ac, the channel bandwidth may be expanded to include 80 MHz and 160 MHz waveforms, and MCS may only refers to modulation and coding. The maximum number of spatial streams may increase from four in 802.11n to eight in 802.11ac. MCS 0-7 may be the same set of modulation and codes rates as in 11n. The two new MCSs in 802.11 ac may be 256-QAM, rate 3/4 and 256-QAM, rate 5/6. FIG. 6B is a chart of MCS's chosen based on a required SNR and margin relative to minimum sensitivity at 10% PER (packet error rate). According to some implementations of 802.11, MCS may be chosen based on measured PER, which may be set at 10%, for example. Measuring the packet error rate may further delay transmission, because a device may need to wait for up to ten cycles to determine whether data transmitted has a packet error rate of 10% or better. Generating two or more A-MPDU's may alleviate this delay, because an AP's processor can select one A-MPDU to transmit in a shorter amount of time based on RSSI (received signal strength indication), SNR (signal to noise ratio), MCS feedback of received data packets, and a PER (packet error rate) of transmission. For example, an access point may generate one A-MPDU with MCS index 3 602 and generate another A-MPDU with MCS index 5 604. The access point may, based on indicators derived from data transmitted by a UE for example, require a change to the MCS having a lower SNR. This may be due, for example, the access point's ability to transmit data to a UE via beamforming without interfering with other neighboring access points (e.g., without triggering a CCA check, as in FIG. 2). The access point may then select the A-MPDU with MCS index 3 and transmit it to the UE.

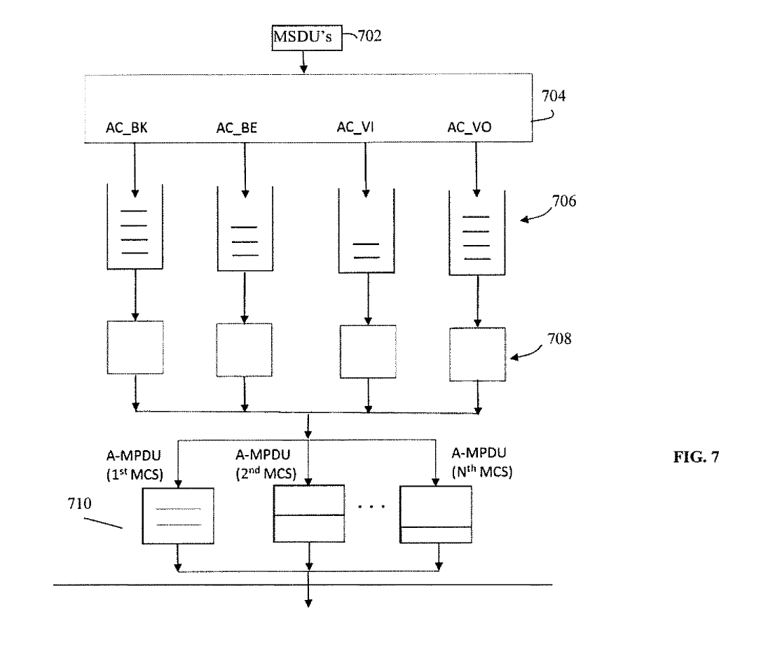

FIG. 7 is a block diagram of generating two or more A-MPDUs in parallel, according to embodiments of the invention. Generating or providing two or more A-MPDU's by aggregating MPDUs may be implemented in one or more processors, hardware, a combination of hardware and software, or software only. MAC service data units (MSDU's) may be transmitted from the data link layer with a particular user priority and may belong to a traffic category (TC) with that user priority and mapped to an AC 704, as described previously in FIG. 2. Each AC may have a dedicated transmit queue 706 and per-queue EDCA functions with internal collision resolution 708. In an A-MSDU, MAC service data units (MSDUs) received from the logical link control layer (LLC) and destined for the same receiver and of the same service category (same traffic identifier or TID) may be accumulated and encapsulated in a single MAC protocol data unit (MPDU). If two (or more) instances of the EDCA access function gain access simultaneously, the internal collision may be resolved by the highest priority AC gaining access and the other AC behaving as if an external collision occurred by doubling its contention window and re-arming for another access attempt. For A-MPDU's 710, fully formed MAC PDUs may be logically aggregated at the bottom of the MAC layer, just prior to transmission to the PHY layer. A-MPDU's 710 aggregate multiple MPDUs to form the PSDU that is passed to the PHY to form the payload of a single transmission. All the MPDUs in an A-MPDU may be addressed to the same receiver and all may be the same service category (same TID). The Duration /ID field in the MAC header of all MPDUs in an A-MPDU may be set to the same value. The maximum number of MPDUs aggregated in an A-MPDU may be in proportion to the rate of selected MCS, thus seeking to achieve equal air time or less than a TXOP limit (transmit opportunity limit, e.g., a time interval during which a UE or AP can send as many frames as possible) among transmissions at each rate. A generated A-MPDU having a MCS with a higher encoding rate may be able to transmit more MPDU's by the end of a TXOP limit, but may require a higher SNR.

Two or more A-MPDUs may be generated in parallel (by processor 114 in FIG. 1, for example). Each A-MPDU may include a different number of bytes according to a selected or aligned MCS. For example, a processor may generate or aggregate, in parallel, a first A-MPDU 710a having a MCS of 0 and a second A-MPDU 710b having an MCS of 1. A third A-MPDU having a different MCS or more A-MPDU's may also be possible. Each A-MPDU may be generated in parallel (e.g., simultaneously or contemporaneously), and stored temporarily in memory, such as in RAM (random access memory) or memory 116. Two or more A-MPDU's can support many candidate MCSs that need less air time than TXOP limit to be selected by a link adaption algorithm Without aggregating multiple A-MPDU's, selection of a an efficient or proper MCS may take longer than if multiple A-MPDU's are generated, or a single A-MPDU that is aggregated and transmitted may cause an MCS mismatch. Link adaptation algorithms may be based on the measured RSSI, SNR of received 802.11 packets and packet error rate (PER) of its transmissions. AP or STA may also change MCS when it receives MCS, CTS and ACK feedbacks from its receiver for fast link adaptation.

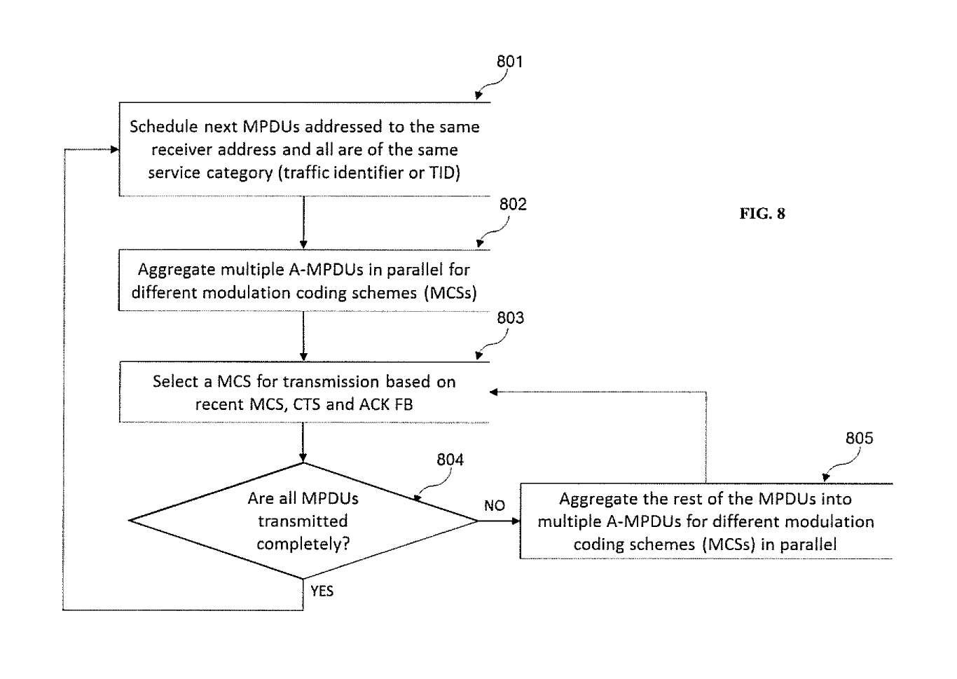

FIG. 8 is a flow chart of a method of aggregating multiple A-MPDUs according to an embodiment of the invention. The operations of FIG. 8 may take place for example at an AP or a station which performs link adaptation. Initially, at operation 801 an AP receives and schedules the next MPDUs addressed to the same receiver address and which may be of the same service category (traffic identifier or TID) from the EDCA for transmission. The AP aggregates multiple A-MPDUs in parallel for different modulation coding schemes (MCSs) at operation 802.

In operation 803, the AP may select a MCS for transmission based on recent MCS, CTS and ACK feedbacks and where it transmits the data within the TXOP limits The TXOP duration may be configurable and may permit multiple data packets to be transmitted within the TXOP duration. An embodiment of the invention may include an AP that is able to receive transmitted data from another neighboring AP may null its Tx and Rx toward the neighbor AP so that both APs are communicating with their STAs. The nulling AP selects a MCS based on received packets from another AP and from its STA, e.g., MCS, CTS and ACK feedbacks. Another embodiment of the invention may include a station that selects a MCS by a link adaption algorithm based on measured RSSI, SNR of received packets and PER of its transmitted packets.

If the AP has not completed transmission of scheduled MPDUs as determined by operation 804, e.g. the result of the transmission at operation 803 does not include all scheduled MPDUs, the AP at operation 805 may aggregate the rest of the scheduled MPDUs into multiple A-MPDUs for different modulation coding schemes (MCSs) in parallel. The flow then proceeds to operation 803. If the result of the determination at operation 804 is positive. The flow then goes back to the beginning, operation 801, for scheduling of the next MPDUs.

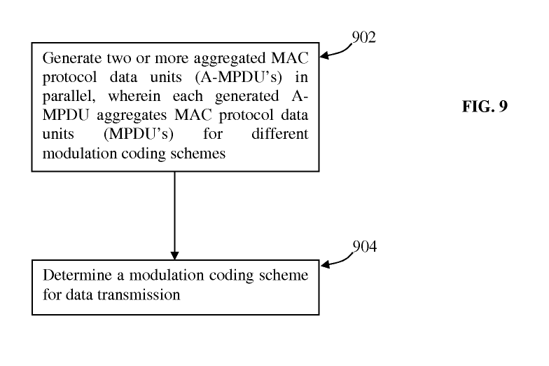

FIG. 9 is a flowchart of a method, according to embodiments of the invention. In operation 902, an access point or other station configurable according to the 802.11 standard may generate, by a processor, two or more aggregated MAC protocol data units in parallel, wherein each generated A-MPDU aggregates different number of MAC protocol data units resulting a different size of PSDU for different modulating coding schemes. In operation 904, a processor may determine a modulation coding scheme for transmitting data, based on, for example, indicators derived from data received by the access point. The indicators may include, for example, RSSI (received signal strength indication), SNR (signal to noise ratio), MCS feedback of received data packets, and a packet error rate of transmission. Based on the determined modulation coding scheme, the processor may select one of the generated A-MPDU's for data transmission to, for example, a user equipment or another access point.

The methods described for embodiments of this invention can be implemented in hardware, a combination of hardware and software or software only. A unique aspect of some embodiments is the possibility for implementation completely in software, for example by augmenting the notational algorithms of the 802.11 xx protocol. Thus embodiments of the invention may take the form of one or more computer readable media, e.g. non-transitory computer readable media, which when implemented on one or more processors in an AP system or a station to perform any of the methods described above.

The methods described herein are applicable to all versions of the 802.11 protocol, especially 802.11 a, b, g, n and ac.

As will be appreciated by someone skilled in the art, aspects of the present invention may be embodied as a system, method or an apparatus. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” In one aspect the invention provides a computer readable medium comprising instructions which when implemented on one or more processors in a computing system causes the system to carry out any of the methods described above. The computer readable medium may be in non-transitory form.

1. A method of wireless data transmission, comprising:
generating, by a processor, two or more aggregated MAC protocol data units (A-MPDU's), said generated A-MPDUs aggregating at least some of the same MAC protocol data units (MPDU's) and addressed to the same receiver, wherein each A-MPDU is generated for a different modulation coding scheme;
determining a modulation coding scheme for data transmission; and
transmitting a subset of the generated A-MPDUs corresponding to the determined modulation coding scheme to the receiver.

2. The method of claim 1, wherein each generated A-MPDU aggregates MPDU's mapped to the same service category.

3. (canceled)

4. The method of claim 1, wherein determining a modulation coding scheme for data transmission is based on at least one indicator derived from received data packets.

5. The method of claim 4, wherein the at least one indicator includes at least one of: RSSI (received signal strength indication), SNR (signal to noise ratio), MCS feedback of received data packets, and a packet error rate of transmission.

6. The method of claim 4, wherein the received data packets are sent from a neighboring access point.

7. The method of claim 4, wherein the received data packets are sent from a user equipment.

8. A wireless data transmission system, comprising:
memory; and
a processor configured to:
generate two or more aggregated MAC protocol data units (A-MPDU's) said generated A-MPDUs aggregating at least some of the same MAC protocol data units (MPDU's) and addressed to the same receiver, wherein each A-MPDU is generated by aggregating MAC protocol data units (MPDU's) for a different modulation coding scheme;
determine a modulation coding scheme for wireless data transmission; and
cause a subset of the generated A-MPDUs corresponding to the determined modulation coding scheme to be transmitted to the receiver.

9. The wireless data transmission system of claim 8, wherein the processor is to generate each of the A-MPDU's by aggregating MPDU's mapped to the same service category.

10. (canceled)

11. The wireless data transmission system of claim 8, wherein the processor is to determine a modulation coding scheme for data transmission based on at least one indicator derived from received data packets.

12. The wireless data transmission system of claim 11, wherein the at least one indicator includes at least one of: RSSI (received signal strength indication), SNR (signal to noise ratio), MCS feedback of received data packets, and a packet error rate of transmission.

13. The wireless data transmission system of claim 11, wherein the processor is to receive the data packets from a neighboring access point.

14. The wireless data transmission system of claim 11, wherein the processor is to receive the data packets from a user equipment.

15. The wireless data transmission system of claim 8, wherein the wireless data transmission is according to an IEEE 802.11 standard.

16. A wireless transceiver, comprising:
a transmitter to transmit data according to an IEEE 802.11 protocol;
a processor to aggregate at least some of the same MPDU's addressed to the same receiver into multiple A-MPDU's, wherein each A-MPDU is for a different modulation coding scheme (MCS); and
a receiver to receive data packets according to the IEEE 802.11 protocol, wherein the processor is further to determine a MCS based on the received data packets and cause transmission of a selected subset of A-MPDU's generated corresponding to the determined MCS.

17. (canceled)

18. The wireless transceiver of claim 16, wherein the transmitter is to determine a MCS based on RSSI (received signal strength indication), SNR (signal to noise ratio), or MCS feedback of received data packets.

19. The wireless transceiver of claim 16, wherein the receiver is to receive data packets from a neighboring access point.

20. The wireless transceiver of claim 16, wherein the receiver is to receive data packets from a user equipment within a coverage area of the wireless transceiver.
